(19) United States
(12) Patent Application Publication
(10) Pub. No.: US 2019/0360498 A1
(43) Pub. Date: Nov. 28, 2019

(54) Fan Blade And Manufacturing Method Thereof

(71) Applicant: Chien-Hsiang Chang, Changhua County (TW)

(72) Inventor: Chien-Hsiang Chang, Changhua County (TW)

(21) Appl. No.: 16/371,101

(22) Filed: Mar. 31, 2019

(30) Foreign Application Priority Data
May 22, 2018 (CN) 201810496972.2

(51) Int. Cl. F04D 29/38; F04D 29/34; F04D 29/32; B27D 1/04; B44C 1/17

(52) U.S. Cl. CPC F04D 29/384; F04D 29/34; F04D 29/325; F05B 2230/90; B44C 1/1729; F05B 2280/4002; B27D 1/04

(57) ABSTRACT

A fan blade has a body made of plywood/fiberboard and having two opposite ends, at least one assembling hole disposed at one of the two opposite ends of the body, and a tip disposed at the other one of the two opposite ends of the body and being flat or curved. A manufacturing method for the fan blade has four steps. Step 1: manufacturing plywood panels/fiberboards by carpentry machining. Step 2: adhering paper/veneers/melamine paper to the plywood panels/fiberboards. Cutting the plywood panels/fiberboards into shape to form the body. Step 3: cleaning debris on the body. Step 4: coating a pattern being consistent with patterns of the upper and bottom surfaces of the body on the circumferential edge of the body by heat pressing. With the pattern printed on the circumferential edge of the body, the fan blade is consistent in appearance.

### BACKGROUND OF THE INVENTION

### 1. Field of the Invention

The present invention relates to a fan, and more particularly to a fan blade and a manufacturing method for producing the same.

### 2. Description of Related Art

Conventional fan blades are commonly made of metal or plastic. Though the conventional fan blades are functioning well, the appearance of the conventional blade is unaesthetic and cannot improve the interior decoration. There are also fan blades made of wood. A wooden fan blade has an upper surface, a bottom surface, and a circumferential edge. Either the upper surface of the wooden fan blade or the bottom surface of the wooden fan blade has wood grain. The circumferential edge is coated by spray painting. Therefore, the circumferential edge of the wooden fan blade and the upper surface and the bottom surface of the wooden fan blade are inconsistent in appearance. The circumferential edge of the wooden fan blade coated by spray painting diminishes the aesthetical appeal of the wooden fan blade.

To overcome the shortcomings of the wooden fan blade, the present invention provides a fan blade and a manufacturing method thereof to mitigate or obviate the aforementioned problems.

### SUMMARY OF THE INVENTION

The main objective of the present invention is to provide a fan blade with a consistent appearance and a manufacturing method for making the fan blade.

The fan blade comprises a body made of plywood/fiberboard and having two opposite ends, at least one assembling hole disposed at one of the two opposite ends of the body, and a tip disposed at the other one of the two opposite ends of the body and being flat or curved. A manufacturing method for the fan blade has four steps. In a first step, manufacturing plywood panels/fiberboards by carpentry machining. In a second step, adhering paper/veneers/melamine papers to two outer surfaces of the plywood panels/fiberboards, and cutting the plywood panels/fiberboards into shape to form the body. In a third step, cleaning debris on the body. In a fourth step, coating a pattern being consistent with the upper surface of the body and the bottom surface of the body on the circumferential edge of the body by heat pressing. With the pattern printed on the circumferential edge of the body, the fan blade in accordance with the present invention is consistent in appearance.

Other objects, advantages, and novel features of the invention will become more apparent from the following detailed description when taken in conjunction with the accompanying drawings.

### BRIEF DESCRIPTION OF THE DRAWINGS

FIG. 1 is a side view of a first embodiment of a fan blade in accordance with the present invention; and

FIG. 2 is a side view of a second embodiment of a fan blade in accordance with the present invention.

### DETAILED DESCRIPTION OF PREFERRED EMBODIMENTS

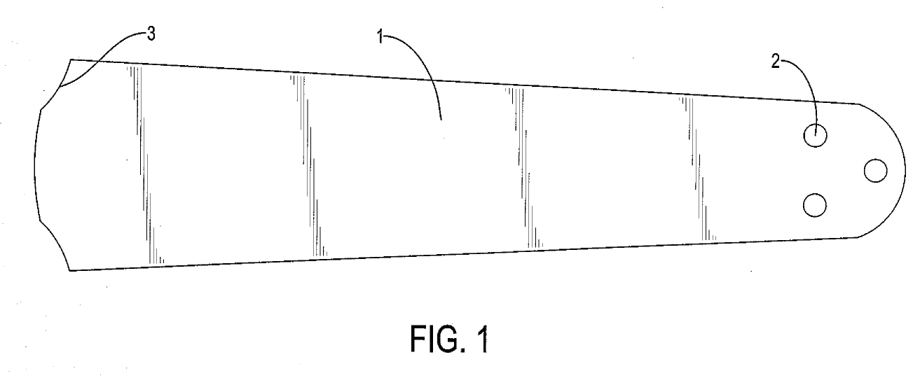

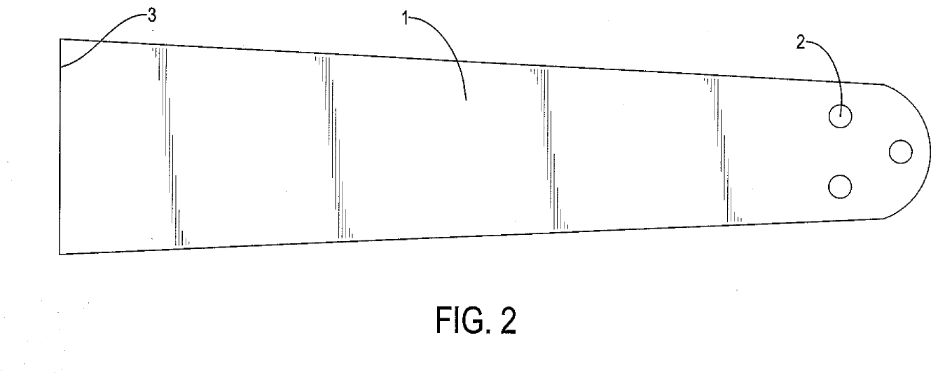

With reference to FIGS. 1 and 2, a fan blade has a body 1, at least three assembling holes 2, and a tip 3.

With reference to FIGS. 1 and 2, the body 1 is made of plywood/fiberboard and has two opposite ends. The at least three assembling holes 2 are equi-angularly disposed at one of the two opposite ends of the body 1. The tip 3 is disposed at the other one of the two opposite ends of the body 1. The tip 3 may be flat as shown in FIG. 2 or curved as shown in FIG. 1.

A manufacturing method for producing the fan blade in accordance with the present invention has four steps.

In a first step: manufacturing plywood panels/fiberboards by carpentry machining. A length of the plywood panels/fiberboards is greater than a largest length of the body 1 by less than 5 millimeters. The body 1 is composed of two overlaid plywood panels/fiberboards. Each one of the two overlaid plywood panels/fiberboards has a thickness being 2.7 millimeters. In a second step: respectively adhering paper/veneers/melamine papers to two surfaces of the plywood panels/fiberboard; cutting the plywood panels/fiberboard into shape to form the body by a woodworking machine, wherein the body 1 has an upper surface, a bottom surface, a circumferential edge, and two opposite ends; grinding the circumferential edge of the body 1; and forming at least one of the at least three assembling holes 2 through one of the two opposite ends of the body 1. In a third step: cleaning debris on the upper surface, the bottom surface, and the circumferential edge of the body 1.

In a fourth step: coating a pattern being consistent with the upper surface of the body 1 and the bottom surface of the body 1 on the circumferential edge of the body 1 by heat pressing. Before coating a pattern on the circumferential edge of the body, a transfer paper passes through a heat press machine to be printed on the circumferential edge of the body 1 to achieve a neat, integral, and a good appearance and to maintain the quality of the pattern subsequently printed.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fan blade comprising:
a body made of plywood or fiberboard and having two opposite ends;
at least one assembling hole disposed at one of the two opposite ends of the body; and
a tip disposed at the other one of the two opposite ends of the body and being flat or curved.

2. The fan blade as claimed in claim 1, wherein
the at least one assembling hole includes at least three assembling holes; and
the at least three assembling holes are equi-angularly disposed.

3. A manufacturing method for the fan blade as claimed in claim 1 comprising:
a first step: manufacturing plywood panels or fiberboards by carpentry machining, wherein a length of each one of the plywood panels or the fiberboards is greater than a largest length of the body by less than 5 millimeters;
a second step: adhering paper/veneers/melamine papers to two outer surfaces of the plywood panels/fiberboards, cutting the plywood panels/fiberboards into shape to form the body by a woodworking machine, the body having an upper surface, a bottom surface, a circumferential edge and two opposite ends, grinding the circumferential edge of the body, and forming the at least one assembling hole through one of the two opposite ends of the body;
a third step: cleaning debris on the upper surface, the bottom surface, and the circumferential edge of the body; and
a fourth step: coating a pattern being consistent with patterns of the upper and bottom surfaces of the body on the circumferential edge of the body by heat pressing.

4. The manufacturing method for the fan blade as claimed in claim 3, wherein
in the first step, the body is composed by two said plywood panels/fiberboards overlaid with each other; and
each one of the two overlaid plywood panels/fiberboards has a thickness being 2.7 millimeters.

5. The manufacturing method for the fan blade as claimed in claim 3, wherein
in the fourth step, before coating a pattern on the circumferential edge of the body, a transfer paper passes through a heat press machine to be printed on the circumferential edge of the body.
